(19) United States
(12) Patent Application Publication
(10) Pub. No.: US 2013/0304670 A1
(43) Pub. Date: Nov. 14, 2013

(54) Computer-Generated Investment Index

(71) Applicant: Stephen Michael Hammers, Brentwood, TN (US)

(72) Inventor: Stephen Michael Hammers, Brentwood, TN (US)

(73) Assignee: COMPASS EFFICIENT MODEL PORTFOLIOS, LLC, Brentwood, TN (US)

(21) Appl. No.: 13/891,640

(22) Filed: May 10, 2013

Related U.S. Application Data
(60) Provisional application No. 61/645,370, filed on May 10, 2012.

(51) Int. Cl. G06Q 40/06

(52) U.S. Cl. CPC G06Q 40/06
USPC 705/36 R

(57) ABSTRACT

A method for generating an investment vehicle index including selecting a universe of investment vehicles and selecting, by a computer, out of the universe of investment vehicles, only those that meet at least one performance criteria, resulting in a first subset. The method also includes selecting, by the computer, out of the first subset, investment vehicles based upon at least one characteristic of the entity associated with each investment vehicles, resulting in a second subset. The method further includes weighting, by the computer, the second subset of investment vehicles based upon their standard deviation of volatility to generate an index of volatility-weighted investment vehicles.

This application claims priority to U.S. Application Ser. No. 61/645,370, the entire contents of which are incorporated by reference herein.

The present invention is directed to an investment index generation system and method, and more particularly, to a computer-generated investment index incorporating volatility weighting with or without volatility weighting.

### BACKGROUND

Various equity and stock indexes are often utilized as benchmarks, as the basis for the formation of mutual funds, and for other purposes. Such indexes are generally desired to provide a maximum return. However, many existing indexes fail to address certain underlying features of their constituent stocks/equities, fail to sufficiently account for volatility, and/or fail to account for other factors.

### SUMMARY

In one embodiment, the present invention is an investment index system and method which accounts for various factors of the equities/stock when populating and forming the index, including in one case earnings. The system and method also include the use of volatility weighting.

### BRIEF DESCRIPTION OF THE DRAWINGS

FIG. 1 is a flow chart illustrating one set of steps for forming a particular index;

FIG. 2 is a chart illustrating the volatility weighting of a simple illustrative index;

FIG. 3 is a graph illustrating the price of an index over time, and illustrating one set of rules for a hedging index; and

FIG. 4 is a schematic illustration of a computer system which can be used to execute the investment index generation method.

### DETAILED DESCRIPTION

### 1. Volatility Weighted Indexing

In one aspect, the present invention takes the form of a system and method which generates an investment index. The index may be applicable to any of a wide variety of investment vehicles, including equities, but is generally described herein as being applied to, and utilized in the context of, the stock of business entities. Formulating and tracking the index may require immediate access to and use of information associated with a large population of underlying equities, and therefore stocks are highly compatible with the system described herein since stocks are typically widely traded, and their qualities and characteristics, and those of the associated entities, can be easily identified and tracked. However, the indexes described herein are not necessarily limited to use with stocks, and can be used with other equities or investment vehicles, including bonds, derivatives, etc.

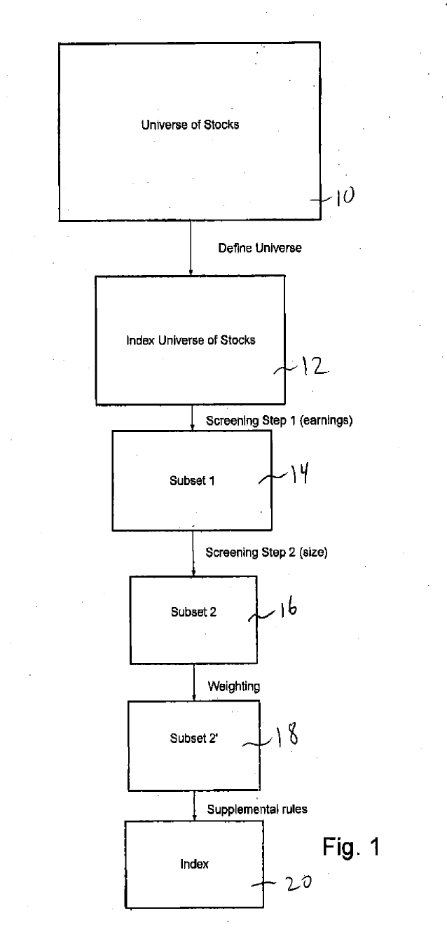

FIG. 1 broadly illustrates a method for generating the index, as described in greater detail below. In order to define any particular index, the method may first begin by defining a universe of all possible stocks which can populate the index (the Index Universe of Stocks 12 of FIG. 1), out of the broader universe of all stocks (Universe of Stocks 10). A screening step or factor can then be applied to the Index Universe of Stocks 12 to identify qualified stocks for use in the index, resulting in a first subset of stocks 14. A second screening step or factor can then be applied to provide a second subset of stocks 16. As will be described in greater detail below, the factors applied during the screening process can take any of a wide variety of forms, including screening based upon the location, size and/or sector of the associated company, earnings criteria, market capitalization, volatility, liquidity and performance. Moreover, although FIG. 1 illustrates two screening steps, nearly any number of search criteria/screening steps may be applied, typically in a serial manner.

After the screening steps are completed, the population of the stock index (i.e. identification of each stock in the stock index) can be considered to be generally formulated. Various weighting factors may then be applied to determine the appropriate weighting of stocks relative to the other stocks in the index (Subset 2′, shown as box 18 in FIG. 1). In one embodiment the index considers earnings per share with volatility weighting, as applied to traditional stock indexes (with sector, country and trading volume criteria). If desired, certain supplemental rules, which may change the makeup of the index in some cases, may be applied, so that the index is formed as desired (Index 20 in FIG. 1)

By way of example, the steps for formulating an index fund, termed the “U.S. Large Cap 500 Volatility Weighted Index” herein, are provided below, and broadly set forth in FIG. 1. In this case, the method begins by identifying the associated index universe of stocks (Index Universe of Stocks 12 of FIG. 1), which in this case is all common stocks traded on any U.S. exchange for companies which are domiciled in the U.S. The meaning of “domiciled within the U.S.” can vary depending upon the wishes of the constructor/operator of the index, but in one case means companies which are headquartered in, incorporated in and/or have a significant business presence in the U.S. It should be noted that, in defining the universe of stocks in this or other cases, the universe can be open-ended and inclusive of nearly any stock, and is not restricted to any particular proprietary funds, indexes or the like. This provides the advantage of providing a broader base of stocks which can capture higher-performing stocks, and also provides greater diversification.

After the universe for the index is identified, a first screening or selecting step may be applied. The result of this first screening step is a first subset of stocks (Subset 1 (box 14) of FIG. 1), which fall within the universe of stocks for the index and meet the first screening criteria. In this particular case the first screening step involves screening out all companies that do not have net positive earnings per share in each of the last four consecutive quarters. Net positive earnings can be determined in various manners, such considering as gross earnings, earnings before write-offs, etc. The screening process can be implemented by considering at earnings per share that are reported in, for example, audited statements provided by the company/entity.

This first screening step based upon earnings helps to ensure that only companies that have sound fundamental financial performance are included in the index. In particular, many current indexes simply consider size and/or sector of the company, but fail to consider at least the basic financial performance of the associated stocks, which can lead to degraded performance. Of course, performance over various other periods of time, besides four consecutive quarters, including more or less than four consecutive quarters and/or performance in a particular number of quarters (e.g. positive earnings in three of the last four quarters; eight of the last ten quarters, etc.) can be utilized.

Rather than solely considering positive earnings over a particular period of time, the first screening step can look at other fundamental financial performance metrics such as various other financial ratios, including but not limited to payout ratio, dividend cover, P/E ratio, dividend yield, EV/EBITDA ratio, as well as profitability ratios, liquidity ratios, activity ratios, debt ratios, and other market ratios or any fundamental criteria. The constructor/operator of the index can select whichever performance criteria is desired (or combinations thereof) to meets the appropriate goals.

Next, a second screening step can be applied, resulting in Subset 2 (box 16) of FIG. 1. The second screening step can consider characteristics of the entity associated with the stock, such as its size, industry, country of domicile, etc. In one particular embodiment, the second screening step includes screening out companies by size such that only the largest companies remain. For example, in the case of the U.S. Large Cap 500 Volatility Weighted Index, the second screening step involves screening out those companies that are not the largest (by market capitalization) 500 stocks of the first subset.

It is noted that in some cases, the first screening step may result in a first subset that has a number of companies that is less than the cut-off for the second screening step (e.g. the first screening step may leave less than 500 companies in the first subset 14). In this case, each of the companies that pass the first screening step can also be considered to pass the second screening step, and in this case there is effectively no second screening step.

Next, a weighting step can be applied to stocks that are in the second subset. Under the weighting process, the qualified stocks (500 stocks in this particular example) are weighted based upon their daily (or other period of time) standard deviation of volatility over a particular period of time, as compared to the aggregate mean volatility for stocks in the second subset. In one case the standard deviation for each stock is measured for each day of trading for a particular period of time (180 days in one case, although the measurement period can vary from 180 days as desired). The standard deviation of the volatility of all of the 500 stocks for that day (or other period of time) is then calculated by, for example, considering the mean, average or other aggregate value of standard deviation for the group. The standard deviation for one particular stock is compared to the aggregate standard deviation, and the difference calculated and tracked to give an idea of the volatility of the stock for that day. In one case the weighting methodology is determined utilizing the formula wᵢ=(1/σᵢ)/Σ[1/σᵢ], wherein the weight of a member in the index (wᵢ) is defined by its own volatility (σᵢ) relative to the volatility of all index members. The reciprocal of volatility is used to capture the inverse relationship between volatility and index weighting in this methodology.

The difference in standard deviation for each stock is then calculated for each day over the 180 day period. By way of example, the difference in standard deviation for a stock is compared to the aggregate standard deviation for each day (e.g. 180 days in the particular example), resulting in 180 differences. The 180 differences for that stock can then be averaged (or their mean determined, or some other measurement made) to thereby give a numerical representation of the volatility of each stock.

The volatility of each stock is then used as a weighting factor, in assembling the index, such that each stock has the same risk (standard deviation) contribution to the index. By way of example, in one case the aggregate mean standard deviation for all 500 stocks may be 15%. In this case, stocks that have a standard deviation greater than 15% have a lower weighting (may have a weighting factor of less than one) and stocks with a standard deviation less than 15% have a higher weighting (may have a weighting factor greater than one).

By way of a more particular example, consider the scenario where the mean standard deviation for the entire index is 15%, stock A has a mean standard deviation of 20%, and stock B has a mean standard deviation of 10%. In this case, stock A can have an associated weighting factor of, for example 0.75, and stock B can have an associated weighting factor of 1.5. In other words, each weighting factor can be calculated by dividing the aggregate mean standard deviation by an individual stock's mean standard deviation. The use of standard deviations to weight the stocks in this manner helps to reduce risk and volatility of the index as a whole, such that more predictable, less risky results are typically provided. The weighting factor is then applied to each stock to determine the weight of each stock, or relative amount each stock effects the index.

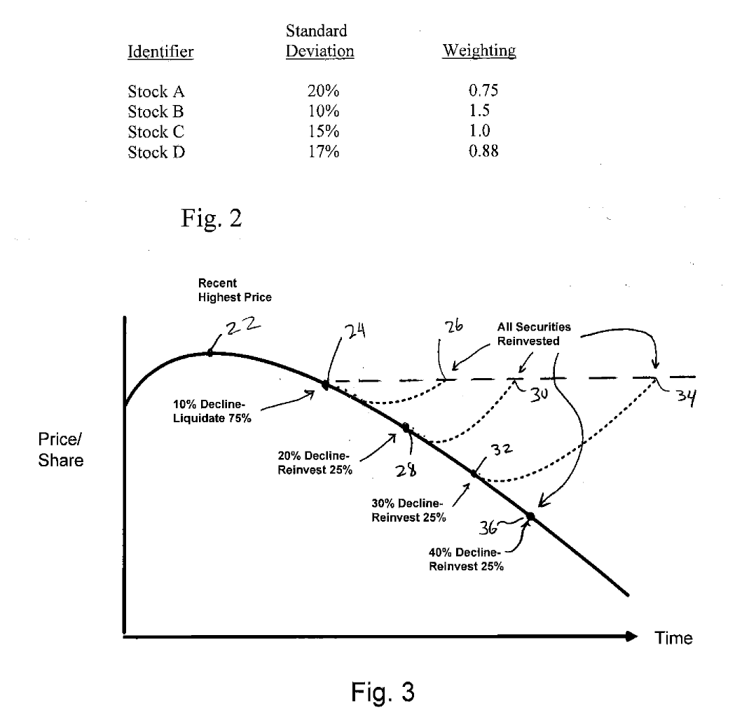

FIG. 2 illustrates how the weighting factor is assigned to each stock based upon sample standard deviations, following the example outlined above. In that particular case, each of the four stocks (Stocks A, B, C and D) have a weighting value calculated as outlined above. Each stock also has a price/share that can be determined from any of a wide number of publicly available sources. The price/share of each stock can be multiplied by its weighting value, resulting in a (price/share×weighting) value. The (price/share×weighting) values of each stock can then be summed, providing a total index value.

The steps set forth above (selecting the universe, applying first and second (or more or less) screening steps, and applying volatility weighting), are executed to generate the investment index. In some cases, these steps can be carried out in any order, and not just the order described above. Moreover, if desired, supplemental steps and rules can be applied to the results to further define the index. For example, in some cases it may be undesirable to have any one sector too dominant within the index. In this case, a supplemental rule may be applied which involves examining the industry or business sector make-up of the stocks in the index, and adjusting the make-up of the index if one (or more) sector constitutes a sufficiently high percentage of the index.

For example, in one case, after the weighting step the index is examined to determine whether any one sector constitutes more than 25% of the index (by either raw numbers of stocks in the sector and/or by proportion according to volatility weighting). The sectors can be defined in a wide variety of manners, but in one embodiment the sectors are those defined by the Global Industry Classification Standards (“GICS”) developed by MSCI, Inc. and Standard & Poor's, and may include for example energy, materials, industrials, consumer discretionary, consumer staples, health care, financials, information technology, telecommunication services and utilities. Of course, the sector threshold value can vary from the 25% example specified herein, as desired to provide the desired sector diversity in the index.

If it is determined that a particular sector constitutes more than 25% of the index, the relative percentage of that sector can be reduced by removing stocks of that sector from the index. In one case, the smallest stock (as determined by market capitalization) in the over-represented sector is removed, and it is then determined whether the industry sector is under the 25% limit. If the associated industry sector is not below the threshold, the next smallest stock in that sector is removed, and the process repeated until the sector is below the 25% limit. The process is then repeated for any other sectors which are over the threshold.

As noted above, it may be undesirable to have any one sector too dominant within the index. It is possible, in some cases, that certain sectors may, at least initially, carry too much weight in the index, particularly due to the first screening step described above which leaves only those companies having a positive earnings per share over a certain period of time. As is well known, the performance of stocks in certain sectors often have a strong correlation. Thus, when the first screening step is applied in this manner, a particular sector could undesirably dominate the index if appropriate adjustments are not made.

The index may include other rules relating to when a stock in the index (and/or when associated entities) is acquired by another stock/entity, or is merged with another stock/entity. In this case, one such supplemental rule may specify that if a stock within the index is acquired by another due to merger or acquisition, the new (acquiring/surviving) stock will remain in the index at least until the index is reconstituted, unless the new (acquiring/surviving) stock does not meet certain qualifications (e.g. in one case, the new stock does not meet the first screening step requiring stocks to have a positive price-to-earnings ratio in each of the last four consecutive quarters).

Of course, various other qualifications can be applied to determine whether the acquiring/surviving stock remains in the index. If the acquiring/surviving company stock does not meet the criteria (e.g. sufficient positive earnings, in one case) the stock may be removed from the index and not replaced unless it later independently re-qualifies. Similar rules can also be applied when an entity/stock in the index acquires another entity/stock.

The index can be regenerated (i.e. re-started from scratch, utilizing the steps above) at periodic intervals. In one case, the index is regenerated every six months (e.g. each March and September in one case), but can be regenerated at other times and at other intervals as desired.

Once the index is generated as set forth above, with the various options set forth herein, and modified by any supplemental rules, if desired, the result is an index comprising stocks of a plurality of companies or entities weighted by a certain value. The market value of each stock can then be tracked, and multiplied by its weighting factor, with the results added together to result in a numerical output value of the index which will fluctuate over time. In this manner, the numerical output value can be used as a benchmark to measure the performance of the index's member stocks, of other indexes or investments, etc. If desired, investment funds, such as mutual funds can be created based upon the index, in which the stocks identified in the index are purchased in volumes corresponding to the weighting factor for each associated stock. The manager of the mutual fund can then track the value fluctuations of the associated mutual fund, provide periodic reports to the investment holders, make payouts as necessary, etc. Further alternately, the index can be considered as an instrument itself which derives its value from the associated stocks, and an associated financial instrument, such as an exchange traded fund based upon the index, can be created and traded.

The example set forth above describe particular parameters that can be used to create/define the U.S. Large Cap 500 Volatility Weighted Index. However, certain parameters relating to defining the universe, defining/applying screening steps, applying weighting and defining/applying supplemental rules can be varied to form various other types of indexes. For example, in one case the universe of stocks potentially populating the index can be defined as all U.S. domiciled common stocks traded on a U.S. exchange that have a market capitalization of less than a certain amount (e.g. $2 billion in one case). All other parameters of the screening, weighting, and secondary rules outlined above for the U.S. Large Cap 500 Volatility Weighted Index may remain the same. In this case, the resultant index can be termed, for example, the U.S. Small Cap 500 Volatility Weighted Index.

Yet another type of index can be formulated by, rather than beginning with the universe of U.S. common stocks, beginning with all international common stocks domiciled in countries defined as developed markets. “Developed markets” can be defined by any of a wide variety of parameters. In one case, however, developed markets could be identified under the Development Market indices provided by MSCI, Inc. and can include, for example, Canada, United States, Austria, Belgium, Denmark, Finland, France, Germany, Greece, Ireland, Israel, Italy, Netherlands, Norway, Portugal, Spain, Sweden, Switzerland, United Kingdom, Australia, Hong Kong, Japan, New Zealand and Singapore. In one case, developed markets are those having a gross domestic product over a particular threshold.

In addition, the universe of stocks may also be required to have a particular liquidity and/or trading volume. Again, the specific parameters for desired liquidity can vary, but in one case sufficient liquidity can be defined as having an average daily trading volume greater than 30,000 shares each day over the previous 30 trading days. Of course, the criteria for defining liquidity/trading volume can be varied as desired. The developed market and liquidity rules can be applied, along with other appropriate screening and weighting rules outlined above for the U.S. Large Cap 500 Volatility Weighted Index, to create an index which can be termed, for example the International 500 Volatility Weighted Index.

In certain cases, such as for the International 500 Volatility Weighted Index, different or additional supplemental rules may apply. For example, for the International 500 Volatility Weighted Index, rather than looking at industry sectors, supplemental rules may be in place to examine particular countries to ensure that one (or more) particular country and/or region is not weighted too heavily in the index. In this case, then, the country/region of origin for each stock is tracked and it is determined whether any one country/region contributes more than 20% (for example) of the stocks in the index (by raw number and/or by weighted values). If a particular country/region of origin constitutes more than the 20% threshold, the smallest stocks, by market capitalization, in the over-represented country/region are removed. The removed stock can be replaced with the largest stock from a different country/region that is not also over-represented. The process is repeated until the weighting for each country/region is below the 20% (or other) threshold.

Rather than focusing upon developed markets, an index can be generated which focuses upon, for example, emerging markets. “Emerging markets” can be those countries defined by the MSCI, Inc. Emerging Markets funds, typically defined as countries having a gross domestic product less than a particular threshold. The remaining rules, supplemental rules, weighting, etc. applied to this index can be the same as or similar to those outlined above, and the generated index can be termed the Emerging Market 500 Volatility Weighted Index.

Yet another index can be created, using algorithms and concepts similar to those outlined above, by limiting the universe to shares/stocks of Real Estate Investment Trust (“REIT”) companies to create an index which can be termed the REIT 100 Volatility Weighted Index. In this case, however, since there may be less REITs to choose from than common stocks, the index can be limited to a lesser amount of investment vehicles and can be limited to, for example, 100 investment vehicles or less in one case. Various sectors within the REITs can also be monitored, in a manner similar to that outlined above for the U.S. Large Cap 500 Volatility Weighted Index, to ensure that there is no maximum sector weighting of greater than a certain percentage (e.g. 25%).

### 2. Volatility Weighted Commodity Index

The system and method outlined above for generating indexes can also be applied to commodity futures and can, in this case, be used to generate an index termed the Commodity Volatility Weighted Index. In this case, the universe of futures can be defined as commodity futures having the highest and/or most liquid trading volume (e.g. the most twenty liquid commodity futures, in one case). However, since commodities do not have any earnings, positive earnings per share are not considered in any screening steps for this index. However, risk weighting, as outlined above, can be applied so that the twenty (or other appropriate number) most liquid commodities are weighted based upon their risk standard deviation as compared to the aggregate risk standard deviation. This embodiment, then, addresses volatility weighting of commodities (with trading volume and sector criteria). Of course, any of a wide variety of indexes with various rules, restrictions, screening criteria, relevant universe and weighting methodologies can be created and implemented as desired. It should be understood that the various indexes described herein provide only a few examples of a variety of indexes which can be generated using the steps set forth herein.

The system and method can also be used to generate a bond index (U.S., international or otherwise), weighted by volatility as outlined above, based upon bond earnings using fundamentals. The system and method can also be used to generate a bond derivative index, weighted by volatility, and solely by volatility in one case.

### 3. Hedging Indexes

Once an index is generated, including but not limited to the U.S. Large Cap 500 Volatility Weighted Index, the U.S. Small Cap 500 Volatility Weighted Index, the International 500 Volatility Weighted Index, the Emerging Markets 500 Volatility Weighted Index, the U.S. REIT 100 Volatility Weighted Index and the Commodity Volatility Weighted Index, or other indexes, hedging principles can be applied to such indexes, resulting in derivative hedge indexes. For example, a hedge index (in one case the U.S. Large Cap 500 Long-Cash Volatility Weighted Index) is based upon the periodic price of an underlying, associated index (the U.S. Large Cap 500 Volatility Weighted Index).

Under the hedging principles set forth herein, if the month (or other predetermined period of time) end price of the underlying fund declines by a certain percent (in one case, compared to a daily (or other period of time) high price within the month), a certain percent of the value invested in the security will be liquidated. For example, in case illustrated in FIG. 3, if the value of the U.S. Large Cap 500 Volatility Weighted Index is determined (at the end of a month) to have declined 10% (point 24) from its recent highest (daily) value 22, then 75% (or some other percentage) of the value of the securities will be liquidated. In this case, then, 75% of the value of the securities are, for example, converted to cash or cash equivalents in a proportional manner such that the remaining 25% of the funds remain invested in the U.S. Large Cap 500 Volatility Weighted Index. In determining the recent highest value 22, such determination does not necessarily have any time limit and can simply be the highest historical value for the underlying index, or alternately various fixed time limits (1, 3, 6 or 12 months, by way of example) may be considered.

If the underlying index declines a particular percentage (e.g. 10% in one case) to cause a partial liquidation, and then declines further in value, rules can be put in place such that if the associated index subsequently increases back to its recent liquidation value 24 (e.g. 10% off of the recent highest value) all previously liquidated funds may then be reinvested in the fund. Such an increase in value in the index is shown by the left-most dotted line path in FIG. 3, and when the dotted line meet the previously liquidated value (the horizontal dashed line (e.g. at point 26) all previously liquidated funds may be automatically reinvested in the fund.

Alternately, if the value of the underlying index continues to decline from the initial liquidation value, shown by the solid line in FIG. 3 to the right of point 24, certain rules may apply to provide for certain types of reinvestment. For example, if the underlying index declines 20% from its recent highest value (at point 28), 25% of the value of the fund at its recent highest price (33% of the previously-liquidated value of the securities) may be reinvested at that time. This reinvestment, after the index has further declined, helps to provide dollar-cost averaging such that the investor can gain the benefits of lower purchase prices. If the index increases back to its initial liquidation value (shown by the middle dotted line path of FIG. 3, terminating at point 30), then all previously liquidated securities are reinvested.

In contrast, if, after declining 20%, the underlying index declines to 30% from its recent highest value (at point 32), another 25% of the value of the fund at its recent highest price (33% of the previously-liquidated value of the securities) may be reinvested in the index. If the index then increases back to its initial liquidation value (shown by the bottom dotted line path terminating at point 34) all previously liquidated securities will are reinvested.

Finally, if, after declining 30% from the recent highest value, the underlying index declines to 40% from its highest value at point 36, the remaining 25% of the value of the fund at its recent highest price (33% of the previously-liquidated value of the securities) can be reinvested back into the index. At this point all previously-liquidated securities may be reinvested. This hedging criteria involves reducing to cash up to 75%, and then dollar cost averaging into the declining market. This hedge strategy is utilized to hedge downside risk.

Of course, as can be seen, the various percentages triggering liquidation/reinvestment, the amount liquidated, and the amount reinvested can vary as desired. In addition, the underlying index to which the hedging options apply can vary beginning with, for example, the indexes described above. However, the hedging strategy is not limited to use with the indexes specified herein, and can be applied to nearly any index, mutual fund, investment, stock, derivative, etc.

Moreover, if desired, in certain cases, the hedging rules can be applied such that decreases in price must remain in place for a certain period of time before a percentage of those securities are liquidated. For example, in one case an index (termed the International 500 Volatility Weighted Index) can be hedged such that if the International 500 Volatility Weighted Index (or some other index, as appropriate) declines 10% from its recent highest value and maintains its value below that 10% threshold for five consecutive trading days, then 75% of the value of the securities are liquidated. If the index increases back to its recent liquidation value, all securities are reinvested. If the underlying index fund declines 20% from its recent highest value and remains below 20% for five consecutive days, then 25% are reinvested back into the index. If the index increases back to its initial liquidation value, all securities are reinvested.

If the underlying index declines 30% from the recent highest value and remains below 30% for five consecutive days, another 25% is reinvested back into the index. Again, if the index increases back to its initial liquidation value, all securities will be reinvested. Finally, if the underlying index declines 40% from its recent highest value and remains below 40% for five consecutive days, the remaining 25% is reinvested back into the index.

### 4. Implementation

Due to the high volume of time-sensitive data needing to be tracked, screened and applied, and the various calculations required to be carried out, the system and method are computer-implemented. For example, a computer is used to set up the index, and may be used to track its value as well as make further adjustments to the index on the fly (e.g. due to acquisition/merger, etc.). As used herein “computer” means a desktop computer, laptop computer, or computer processor combined with supporting elements (real or virtualized) such as hardware, firmware, and memory supporting software in execution. One or more computers can reside in or on a server in various embodiments and the server can itself be comprised of multiple computers. One or more computers can reside within a process and/or thread of execution, and a computer can be localized at one location and/or distributed between two or more locations.

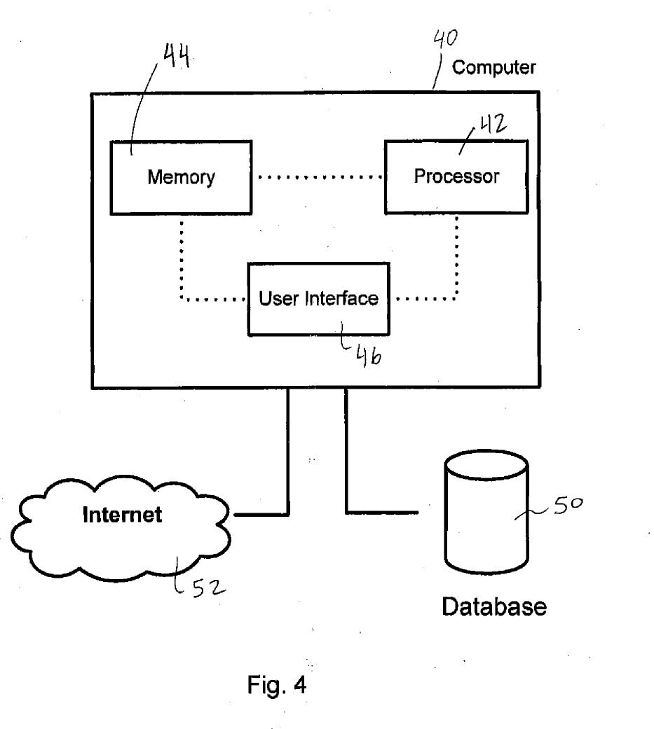

As shown in FIG. 4, a computer 40 can include a processor 42, a memory 44, and a user interface 46 (which can include, for example, a keyboard, mouse or other cursor control device, other input devices, screen/monitor, printer, etc.) to receive inputs from, and provide outputs to, a user. The computer 40 can be operatively coupled to a database 50 which stores information relating to investment vehicles and/or the index, including but not limited to the identity of the universe of stocks, the identity of the universe of stocks for an index, daily performance of the stocks, historical performance of the stocks, make-up of generated indexes, screening rules, weighting algorithms, supplemental rules, etc. As used herein “database” means any of a number of different data stores that provide searchable indices for storing, locating and retrieving data, including without limitation, relational databases, associative databases, hierarchical databases, object-oriented databases, network model databases, dictionaries, flat file/XML datastores, flat file systems with spidering or semantic indexing, and the like. The data may be stored in persistent storage such as hard disk drives or non-volatile memory. Alternately, or in addition, the same information can be stored in the random access memory of the computer 40, and thus also be considered a database.

Moreover, such information, including but not limited to the identity of the universe of stocks, the identity of the universe of stocks for an index, daily performance of the stocks, historical performance of the stocks, make-up of generated indexes, screening rules, weighting algorithms, supplemental rules, etc. is manipulated by software stored in the memory 44 and/or the processor 42. The software may be able to be read/executed/acted upon by the processor 42. As used herein, “software” means one or more computer readable and/or executable instructions or programs that cause a computer to perform functions, actions and/or behave in a desired manner. The instructions may be embodied in various forms such as routines, algorithms, modules, methods, threads, and/or programs. Software may also be implemented in a variety of executable and/or loadable forms including, but not limited to, stand-alone programs, function calls (local and/or remote), servelets, applets, instructions stored in a memory, part of an operating system or browser, bytecode, interpreted scripts and the like. It should be appreciated that the computer readable and/or executable instructions can be located on one computer and/or distributed between two or more communicating, co-operating, and/or parallel processing computers or the like and thus can be loaded and/or executed in serial, parallel, massively parallel and other manners. It should also be appreciated that the form of software may be dependent on various factors, such as the requirements of a desired application, the environment in which it runs, and/or the desires of a particular designer/programmer. The software may be stored on a tangible medium, such as memory, on a hard disk drive, on a compact disc, flash drive, etc.

The computer may also be connected to the internet 52, as shown in FIG. 4, to receive inputs and provide outputs. The computer 40 can communicate with the internet 52 or other computers via computer communications. For the purposes of this application “computer communications” means communication between two or more computers or electronic devices, and can take the form of, for example, a network transfer, a file transfer, an applet transfer, an email, a hypertext transfer protocol (HTTP) message, a datagram, an object transfer, a binary large object (BLOB) transfer, and so on. Computer communication can occur across a variety of mediums by a variety of protocols, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and various other systems.

In order to track what can be large amounts of data relating to the price and other information relating to investment vehicles (e.g., stock), indexes or other relevant information, the computer 40 can be connected to the internet 52 or other computers such that the computer 40 automatically receives such input. The received information can then be used to update the index population, update the numerical output value, regenerate the index, etc. The computer connection to the internet 52 also allows the computer 40 to provide output to others or other computers, including those interested in tracking the numerical output value of the index as a benchmark, for investment purposes, etc.

The various functions described above may each be provided or contained in their own module. For example, the system may utilize a universe module for determining the associated universe for each stock; a first screening module for applying the first screening rules; a second screening module for applying the second screening rules; a weighting module for weighting each stock; a supplemental rules module for applying supplemental rules, etc. Each module can be a block of software, code, instructions or the like which, when executed by the computer 40, provide the desired functions. Each module may be able to interact with the other modules, and may not necessarily be discrete and separate from the other modules, the reader, or other components of the reader/system. The modules in the system may be functionally and/or physically separated, but can share data, outputs, inputs, or the like to operate as a single system and provide the functions described herein.

Although the invention is shown and described with respect to certain embodiments, it should be clear that modifications will occur to those skilled in the art upon reading and understanding the specification, and the present invention includes all such modifications.

What is claimed is:

1. A method for generating an investment vehicle index comprising:
selecting or receiving a universe of investment vehicles;
selecting, by a computer, out of the universe of investment vehicles, only those that meet at least one performance criteria, resulting in a first subset;
selecting, by the computer, out of the first subset, investment vehicles based upon at least one characteristic of the entity associated with each investment vehicles, resulting in a second subset; and
weighting, by the computer, the second subset of investment vehicles based upon their volatility to generate an index of volatility-weighted investment vehicles.

2. The method of claim 1 wherein the investment vehicles are stocks.

3. The method of claim 2 wherein the at least one performance criteria is positive earnings per share over a predetermined period of time.

4. The method of claim 3 wherein the predetermined period of time is four consecutive quarters.

5. The method of claim 2 wherein the third selecting step includes selecting, by the computer, out of the first subset, the largest stocks based upon market capitalization.

6. The method of claim 5 wherein the largest stocks include the largest 500 companies.

7. The method of claim 1 wherein the weighting step involves weighting each investment vehicle of the second subset of investment vehicles based upon a computer-generated standard deviation of volatility for that investment vehicle compared to a computer-generated aggregate standard deviation of volatility of the second subset.

8. The method of claim 1 wherein the weighting step involves weighting each investment vehicle of the second subset of investment vehicles based upon a computer-generated standard deviation of volatility for that investment vehicle compared to a computer-generated mean standard deviation of volatility of the second subset.

9. The method of claim 1 wherein the weighting step includes increasing the weight of investment vehicles that have lower volatility compared to investment vehicles that have higher volatility.

10. The method of claim 1 wherein the weighting step includes weighting each investment vehicle in the second subset in a manner such that each investment vehicle has the same volatility risk.

11. The method of claim 1 further including the step of selling a mutual fund which includes the second subset of investment vehicles in amounts as weighted by the weighting step.

12. The method of claim 1 further including the step of tracking the aggregate financial performance of an investment vehicle portfolio which includes the second subset of investment vehicles in proportions as weighted by the weighting step.

13. The method of claim 1 further including the step of tracking the aggregate financial performance of an investment vehicle portfolio which includes only the second subset of investment vehicles in proportions as weighted by the weighting step.

14. The method of claim 1 wherein the third selecting step includes selecting investment vehicles based upon their county of domicile.

15. The method of claim 1 wherein the method further includes selecting investment vehicles based upon their liquidity.

16. The method of claim 1 wherein the method further includes examining, by the computer, the sector of each investment vehicle in the second subset, and if it is determined that at least one sector is over-represented in the second subset, removing at least one investment vehicles from the over-represented sector from the second subset.

17. The method of claim 1 wherein the method further includes examining, by the computer, the country of domicile each investment vehicle in the second subset, and if it is determined that at least one country is over-represented in the second subset, removing at least one investment vehicle from the over-represented country from the second subset.

18. The method of claim 1 wherein the first selecting step is performed by a computer operatively coupled to a database storing information thereon relating to the universe of investment vehicles.

19. The method of claim 1 wherein the investment vehicles are selected from a non-proprietary universe.

20. A computer readable storage medium having computer readable program code stored therein, the computer readable program code being configured to cause a computer to:
select or receive a universe of investment vehicles;
select, out of the universe of investment vehicles, only those that meet at least one performance criteria, resulting in a first subset;
select, out of the first subset, investment vehicles based upon at least one characteristic of each entity associated with the investment vehicles, resulting in a second subset; and
weight the second subset of investment vehicles based upon their volatility to generate an index of volatility-weighted investment vehicles.

21. A system for generating a stock index, the system comprising a computer including:
a universe selecting module configured to select or receive a universe of investment vehicles;
a first selecting module configured to select, out of the universe of investment vehicles, those that meet at least one performance criteria, resulting in a first subset;
a second selecting module configured to select, out of the first subset, investment vehicles based upon at least one characteristic of the entity associated with each investment vehicle, resulting in a second subset;
a weighting module configured to weight the second subset of stocks based upon their volatility; and
a database configured to store a generated index including the weighted second subset of stocks.

22. A method for generating a commodity index comprising:
selecting or receiving a universe of commodity investment vehicles;
selecting, by a computer, out of the universe of commodity investment vehicles, only those that have a sufficient liquidity, resulting in a subset; and
weighting, by a computer, the commodity investment vehicles in the subset based upon their volatility to generate an index of volatility-weighted commodity investment vehicles.

23. A method for managing a fund including the steps of:
generating, by a computer, an index of volatility-weighted investment vehicles;
assembling a fund comprised of holdings representative of the index with a weighting of holdings equal to the volatility-weighting of the investment vehicles;
if the value of the fund drops in value by more than a first percentage, liquidating a fraction of the holdings while maintaining a weighting of holdings equal to the volatility-weighting of the investment vehicles; and
after the liquidating step:
if the index increases in value such that it has a value equal to or greater than that at the time of the liquidating step, reinvesting all proceeds of the previously liquidated portions of holdings while maintaining a weighting of holdings equal to the volatility-weighting of the investment vehicles; and
if the index drops in value by more than a second percentage, reinvesting a portion of the proceeds of the previously liquidated portions of holdings while maintaining a weighting of holdings equal to the volatility-weighting of the investment vehicles.

24. The method of claim 23 wherein the first and second percentages are both measured as compared to a recent highest price of the fund.

25. The method of claim 23 wherein the second percentage is greater than the first percentage.

26. The method of claim 23 wherein, after the index drops in value by more than the second percentage, if the index increases in value such that it has a value equal to or greater than that at the time of the liquidating step, all proceeds of the previously liquidated portions of holdings are reinvested while maintaining a weighting of holdings equal to the volatility-weighting of the investment vehicles, and if the index drops in value by more than a third percentage, a portion of the proceeds of the previously liquidated portions of investment vehicles are reinvested while maintaining a weighting of holdings equal to the volatility-weighting of the investment vehicles.

27. The method of claim 26 wherein, after the index drops in value by more than the third percentage, if the index drops in value by more than a fourth percentage, a portion of the proceeds of the previously liquidated portions of investment vehicle holdings are reinvested while maintaining a weighting of holdings equal to the volatility-weighting of the investment vehicles.

28. The method of claim 27 wherein if the index drops in value by more than the fourth percentage, all previously liquidated proceeds of the investment vehicle holdings are reinvested while maintaining a weighting of holdings equal to the volatility-weighting of the investment vehicles.

29. The method of claim 27 wherein the first, second, third and fourth percentages are all measured as compared to a baseline value of the fund, and wherein the first percentage is smaller than the second, third and fourth percentages, the second percentage is smaller than the third and fourth percentages, and the third percentage is smaller than the fourth percentage.

30. The method of claim 23 wherein the portion of proceeds reinvested is ⅓ of the value of the previously liquidated portions of holdings.

31. A computer readable storage medium having computer readable program code stored therein, the computer readable program code being configured to cause a computer to:
generate an index of volatility-weighted investment vehicles;
track a fund comprised of holdings representative of the index with a weighting of holdings equal to the volatility-weighting of the investment vehicles such that if the value of the fund drops in value by more than a first percentage, a fraction of holdings are liquidated while maintaining a weighting of holdings equal to the volatility-weighting of the investment vehicles; and
after the liquidating step:
if the index increases in value such that it has a value equal to or greater than that at the time of the liquidating step, causing all proceeds of the previously liquidated portions of holdings to be reinvested while maintaining a weighting of holdings equal to the volatility-weighting of the investment vehicles; and
if the index drops in value by more than a second percentage, causing a portion of the proceeds of the previously liquidated portions of holdings to be reinvested while maintaining a weighting of holdings equal to the volatility-weighting of the investment vehicles.
